(19) United States
(12) Patent Application Publication
(10) Pub. No.: US 2023/0151828 A1
(43) Pub. Date: May 18, 2023

(54) TELESCOPIC ACTUATOR, ACTUATING SYSTEM AND MOTION SIMULATING APPARATUS

(71) Applicant: BROGENT TECHNOLOGIES INC., Kaohsiung city (TW)

(72) Inventor: Cheng-Yi LI, Taipei (TW)

(21) Appl. No.: 17/971,562

(22) Filed: Oct. 22, 2022

(30) Foreign Application Priority Data
Nov. 12, 2021 (TW) 110142226

(51) Int. Cl. F15B 1/24; G09B 9/14

(52) U.S. Cl. CPC F15B 1/24; G09B 9/14

(57) ABSTRACT

A telescopic actuator includes a first segment having a first hollow cavity, a second segment having a second hollow cavity, a third segment having a third hollow cavity, and a first port and a second port. The second segment is slidably connected to the first segment through the first hollow cavity, and the third segment is slidably connected to the second segment through the second hollow cavity, the second hollow cavity being insulated from the first hollow cavity and communicating with the third hollow cavity. The first port is configured to flow fluid into and out of the first hollow cavity, and the second port is configured to flow fluid into and out of the second hollow cavity and the third hollow cavity. Embodiments described herein also include a motion simulating apparatus and an actuating system incorporating the telescopic actuator.

### CROSS-REFERENCE TO RELATED APPLICATION(S)

This application claims priority to Taiwan patent application no. 110142226 filed on Nov. 12, 2021.

### BACKGROUND

### 1. Field of the Invention

The present invention relates to telescopic actuators, in particular to telescopic actuators suitable for use with actuating systems and motion simulating apparatuses.

### 2. Description of the Related Art

Telescopic actuators are suitable for use in environments having a limited space. Conventionally, a telescopic actuator includes multiple movable cylinders, wherein an intermediate cylinder can extend along with a preceding cylinder until the intermediate cylinder contacts against a next cylinder and consequently stops. Conversely, when retracting, the preceding cylinder first comes in contact with the intermediate cylinder and then urges the intermediate cylinder to retract.

In practice, the conventional telescopic actuator may provide an output force that exceeds an expected output during operation, and the collision occurring between cylinders may produce undesirable vibration and noise and cause structural damages. In order to reduce vibration and noise, a conventional approach consists in adding springs to absorb the collision energy. However, the added springs cannot totally eliminate the collision between cylinders, and still cannot address the issue of excessive output forces during operation.

Therefore, there is a need for a construction that can address at least the aforementioned issues.

### SUMMARY

The present application describes a telescopic actuator and an actuating system that can address at least the foregoing issues, and a motion simulating apparatus incorporating the telescopic actuator.

According to one embodiment, a telescopic actuator includes a first segment having a first hollow cavity, a second segment having a second hollow cavity, a third segment having a third hollow cavity, and a first and a second port. The second segment is slidably connected to the first segment through the first hollow cavity, and the third segment is slidably connected to the second segment through the second hollow cavity, the second hollow cavity being insulated from the first hollow cavity and communicating with the third hollow cavity. The first port is configured to flow fluid into and out of the first hollow cavity, and the second port is configured to flow fluid into and out of the second hollow cavity and the third hollow cavity.

According to one embodiment, a motion simulating apparatus includes a support base, an occupant platform adapted to carry one or more occupants, and the telescopic actuator, wherein the first segment of the telescopic actuator is connected to the support base, and the third segment of the telescopic actuator is connected to the occupant platform.

According to one embodiment, an actuating system includes a telescopic actuator and a pressure source. The telescopic actuator includes a plurality of telescopic segments, a first port and a second port, wherein the telescopic segments at least include a first segment having a first hollow cavity, and a second segment having a second hollow cavity, the second segment being slidably connected to the first segment through the first hollow cavity and the first and second hollow cavities being insulated from each other, the first port being configured to flow fluid into and out of the first hollow cavity, and the second port being configured to flow fluid into and out of the second hollow cavity. The pressure source is respectively connected to the first port and the second port via a first conduit and a second conduit. The second segment has an end that is located inside the first hollow cavity and has a first end surface and a second end surface facing opposite directions, the first end surface being configured to contact with a fluid inside the first hollow cavity, the second end surface being configured to contact with a fluid inside the second hollow cavity, and the pressure source being operable to create different fluid pressures in the first hollow cavity and the second hollow cavity so that the second segment is in a floating state and is movable in an extending direction in a stop-and-go manner.

### BRIEF DESCRIPTION OF THE DRAWINGS

FIG. 1 is a perspective view illustrating an embodiment of a telescopic actuator;

FIG. 2 is a perspective view illustrating the telescopic actuator of FIG. 1 under another angle of view;

FIG. 3 is a cross-sectional view of the telescopic actuator shown in FIG. 1;

FIG. 4 is a schematic view illustrating an embodiment of an actuating system; and

FIG. 5 is a schematic view illustrating an embodiment of a motion simulating apparatus.

### DETAILED DESCRIPTION OF THE EMBODIMENTS

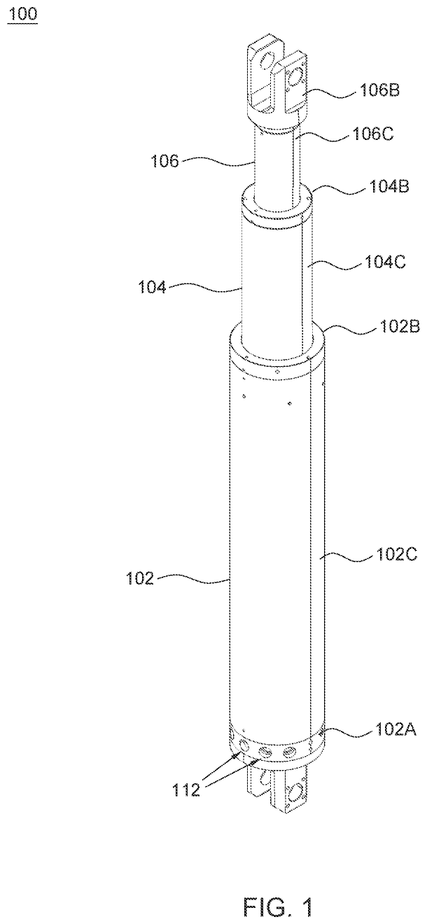

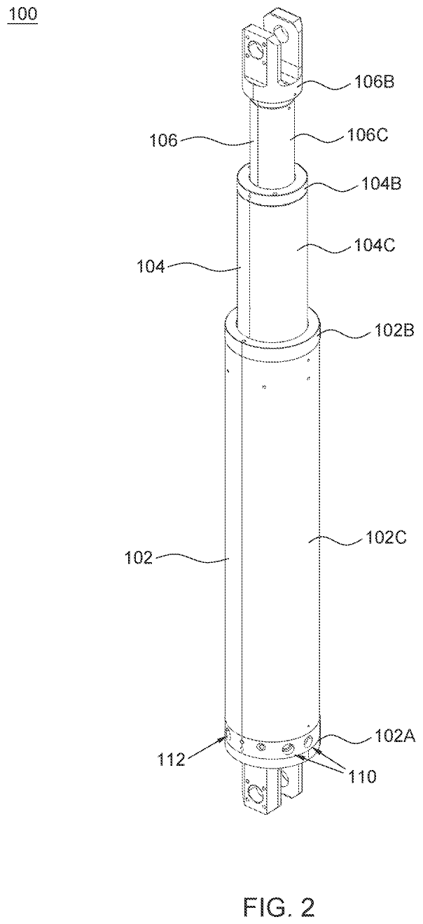

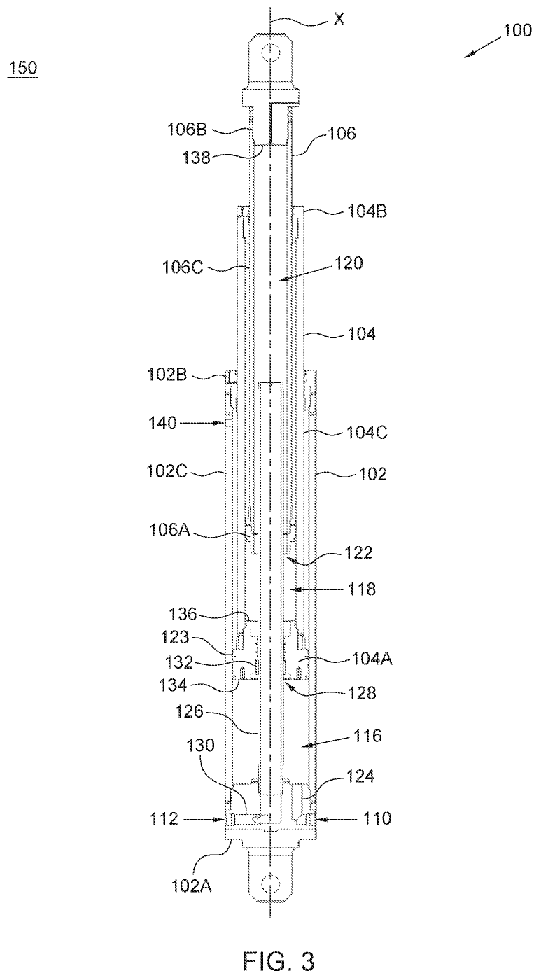

FIGS. 1 and 2 are perspective views illustrating an embodiment of a telescopic actuator 100 under different angles of view, and FIG. 3 is a cross-sectional view illustrating the telescopic actuator 100. Referring to FIGS. 1-3, the telescopic actuator 100 includes three stages or segments 102, 104 and 106, and a plurality of ports 110 and 112. Each of the segments 102, 104 and 106 can be formed as a tubular rod having a hollow interior. The segments 102, 104 and 106 are slidably connected to one another so that the segments 104 and 106 can slide along a lengthwise axis X of the telescopic actuator 100 relative to the segment 102 for extending outward and retracting inward. The telescopic actuator 100 is actuated by flowing a fluid therein, wherein a fluid can flow into and/or out of the segments 102, 104 and 106 through the ports 110 and 112 during the telescopic movement of the segments 104 and 106. For example, a fluid can be flowed through the ports 110 and 112 into the segments 102, 104 and 106 to cause extension of the segments 104 and 106. When the segments 104 and 106 retract owing to the application of an external force that is greater than an opposite force resulting from an inner fluid pressure, fluid can flow through the ports 110 and 112 out of the segments 102, 104 and 106.

Referring to FIGS. 1-3, the segment 102 has a hollow cavity 116 that extends between two opposite ends 102A and 102B of the segment 102 and is at least partially delimited by a sidewall 102C of the segment 102. The sidewall 102C extends along the lengthwise axis X, and is connected to the two ends 102A and 102B of the segment 102. The segment 104 has a hollow cavity 118 that extends between two opposite ends 104A and 104B of the segment 104 and is at least partially delimited by a sidewall 104C of the segment 104. The sidewall 104C extends along the lengthwise axis X, and is connected to the two ends 104A and 104B of the segment 104. The segment 106 has a hollow cavity 120 that extends between two opposite ends 106A and 106B of the segment 106 and is at least partially delimited by a sidewall 106C of the segment 106. The sidewall 106C extends along the lengthwise axis X, and is connected to the two ends 106A and 106B of the segment 106.

The segment 104 is slidably connected to the segment 102 through the hollow cavity 116 with the end 104A of the segment 104 disposed inside the hollow cavity 116 between the two ends 102A and 102B of the segment 102, the end 104B of the segment 104 extending outward from the end 102B of the segment 102. The segment 104 can thereby slide along the lengthwise axis X relative to the segment 102 for retracting into or extending outside the segment 102 at the end 102B thereof. The course of the segment 104 relative to the segment 102 can be delimited by the two ends 102A and 102B of the segment 102, wherein a greatest extending length of the segment 104 relative to the segment 102 can correspond to a state where the end 104A of the segment 104 is located adjacent to the end 102B of the segment 102.

The segment 106 is slidably connected to the segment 104 through the hollow cavity 118 with the end 106A of the segment 106 disposed inside the hollow cavity 118 between the two ends 104A and 104B of the segment 104, the end 106B of the segment 106 extending outward from the end 104B of the segment 104. The segment 106 can thereby slide along the lengthwise axis X relative to the segments 102 and 104 for retracting into or extending outside the segment 104 at the end 104B thereof. The course of the segment 106 relative to the segment 104 can be delimited by the two ends 104A and 104B of the segment 104, wherein a greatest extending length of the segment 106 relative to the segment 104 can correspond to a state where the end 106A of the segment 106 is located adjacent to the end 104B of the segment 104.

Within the telescopic actuator 100, the hollow cavity 118 of the segment 104 and the hollow cavity 120 of the segment 106 communicate with each other and form a connected cavity so that a fluid fed into any of the hollow cavities 118 and 120 can create a substantially equal pressure therein. For example, the end 106A of the segment 106 inside the hollow cavity 118 can have an opening 122 through which the hollow cavity 120 of the segment 106 can communicate with the hollow cavity 118 of the segment 104. Moreover, the hollow cavity 118 of the segment 104 and the hollow cavity 120 of the segment 106 are insulated from the hollow cavity 116 of the segment 102 so that no fluid flows between the hollow cavity 116 and the hollow cavities 118 and 120. Accordingly, a fluid can be respectively flowed into the hollow cavity 116 and the connected cavity formed by the hollow cavities 118 and 120 to create different pressures therein.

According to an embodiment, the hollow cavity 118 of the segment 104 can be insulated from the hollow cavity 116 of the segment 102 so that no fluid flows between the hollow cavity 116 and the hollow cavity 118. For example, the end 104A and the sidewall 104C of the segment 104 inside the hollow cavity 116 of the segment 102 can insulate the hollow cavity 118 of the segment 104 from the hollow cavity 116 of the segment 102 so that the hollow cavity 116 of the segment 102 does not communicate with the hollow cavity 118 of the segment 104 and the hollow cavity 120 of the segment 106. Accordingly, fluid can be respectively flowed into the connected cavity of the hollow cavities 118 and 120 and a space inside the hollow cavity 116 between the end 102A of the segment 102 and the end 104A of the segment 104 to create different pressures therein.

According to an example of construction, the end 104A of the segment 104 can have a circumference provided with a fluid seal 123 configured to insulate the space inside the hollow cavity 116 between the end 102A of the segment 102 and the end 104A of the segment 104 from the space inside the hollow cavity 116 between the end 102B of the segment 102 and the end 104A of the segment 104, whereby fluid flowing between the two insulated spaces can be prevented.

According to another example of construction, the fluid seal 123 may be omitted, and limited fluid flowing may be allowed between the space inside the hollow cavity 116 between the end 102A of the segment 102 and the end 104A of the segment 104 and the space inside the hollow cavity 116 between the end 102B of the segment 102 and the end 104A of the segment 104.

Referring to FIGS. 1-3, the port 110 can communicate with the hollow cavity 116 of the segment 102 so that a fluid can flow through the port 110 into and out of the hollow cavity 116. According to an example of construction, the port 110 is provided on the segment 102. For example, the port 110 can be placed on the end 102A of the segment 102, and can communicate with the hollow cavity 116 via a channel 124 provided inside the end 102A of the segment 102. A fluid can thereby flow through the port 110 and the channel 124 into and out of the space that is located inside the hollow cavity 116 between the end 102A of the segment 102 and the end 104A of the segment 104.

The port 112 can communicate with the hollow cavity 118 of the segment 104 and the hollow cavity 120 of the segment 106 so that a fluid can flow through the port 112 into and out of the hollow cavities 118 and 120. According to an example of construction, the port 112 can be provided on the segment 102 and can be connected to a flowing tube 126 disposed inside the segment 102, whereby a fluid can flow through the port 112 and the flowing tube 126 into and out of the hollow cavities 118 and 120. For example, the end 104A of the segment 104 can have an opening 128, and the flowing tube 126 can be connected to the end 102A of the segment 102 inside the hollow cavity 116 thereof and extend through the opening 128 on the end 104A of the segment 104 into the hollow cavity 118. The port 112 can be placed on the end 102A of the segment 102, and can be connected to the flowing tube 126 via a channel 130 provided inside the end 102A of the segment 102. The port 112, the channel 130 and the flowing tube 126 can thereby communicate with one another. The flowing tube 126 extends along the lengthwise axis X, and has a length configured to accommodate a greatest extension of the segment 104 relative to the segment 102. According to an example of construction, the flowing tube 126 can extend along the lengthwise axis X inside the hollow cavity 116 of the segment 102, through the opening 128 on the end 104A into the hollow cavity 118 of the segment 104, and through the opening 122 on the end 106A into the hollow cavity 120 of the segment 106.

According to an example of construction, the end 104A of the segment 104 can have a fluid seal 132 disposed adjacent to the opening 128. The fluid seal 132 can be disposed around a circumference of the flowing tube 126 so as to prevent fluid flowing through the opening 128 between the hollow cavity 116 of the segment 102 and the hollow cavity 118 of the segment 104. The space inside the hollow cavity 116 between the end 102A of the segment 102 and the end 104A of the segment 104 can be thereby insulated from the hollow cavity 118 of the segment 104.

Within the telescopic actuator 100, the end 104A of the segment 104 is located inside the hollow cavity 116 of the segment 102 and has two end surfaces 134 and 136 facing opposite directions. The end surface 134 is configured to contact with a fluid inside the hollow cavity 116, the end surface 136 is configured to contact with a fluid inside the hollow cavity 118, and the end surface 134 can have a surface area greater than that of the end surface 136. Moreover, the end 106B of the segment 106 has an end surface 138 that faces the end 104A of the segment 104 and is configured to contact with a fluid inside the hollow cavity 120, the end surface 136 having a surface area greater than that of the end surface 138.

With the aforementioned construction, a fluid may be flowed into the hollow cavity 116 between the end 102A of the segment 102 and the end 104A of the segment 104 to create a fluid pressure P1 therein, and a fluid can be flowed into the hollow cavity 118 of the segment 104 and the hollow cavity 120 of the segment 106 to create a fluid pressure P2 therein that can differ from the fluid pressure P1. During operation, the hollow cavity 116 of the segment 102 thus can receive a fluid that contacts with the end surface 134 and creates a buffer pressure, which can result in a pushing force applied on the end surface 134 that tends to offset an opposite force applied on the end surface 136 owing to a fluid pressure inside the hollow cavities 118 and 120. Accordingly, the segment 104 may be configured to be in a floating state relative to the segments 102 and 106 during extending and retracting movements along the lengthwise axis X, which can prevent excessive impact of the segment 104 against the segments 102 and 106 that could produce undesirable vibration and noise.

According to some embodiments, the telescopic actuator 100 is powered by compressed gas, and the ports 110 and 112 are gas ports. According to other embodiments, the telescopic actuator 100 is powered by gas and liquid, one of the ports 110 and 112 being a gas port configured to receive the passage of compressed gas, and the other one of the ports 110 and 112 being a liquid port configured to receive the passage of liquid. According to some other variant embodiments, the telescopic actuator 100 is powered by liquid, and the ports 110 and 112 are liquid ports.

According to the needs, the telescopic actuator 100 may include additional ports configured to flow fluids during operation of the segments 104 and 106. For example, the segment 102 may have a port 140 disposed adjacent to the end 102B, as shown in FIG. 3. The port 140 is spaced apart from the ports 110 and 112 along the lengthwise axis X, and communicates with a space inside the hollow cavity 116 between the end 102B of the segment 102 and the end 104A of the segment 104. The end 104A of the segment 104 can slide within the hollow cavity 116 of the segment 102 between the two ports 110 and 140, wherein a fluid outflow can occur through the port 140 while a fluid inflow occurs through the ports 110 and 112, and a fluid inflow can occur through the port 140 while a fluid outflow occurs through the ports 110 and 112.

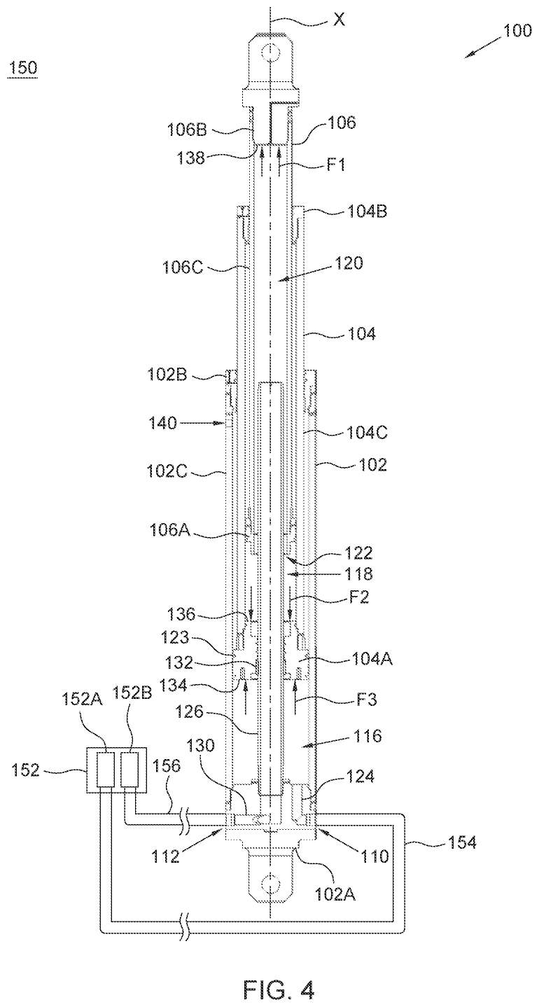

In conjunction with FIGS. 1-3, FIG. 4 is a schematic view illustrating an embodiment of an actuating system 150. Referring to FIGS. 1-4, the actuating system 150 includes the telescopic actuator 100 and a pressure source 152. The pressure source 152 is connected to the port 110 of the telescopic actuator 100 via a conduit 154, and is connected to the port 112 of the telescopic actuator 100 via a conduit 156. During operation, one or more fluid supplied by the pressure source 152 can be flowed through the conduits 154 and 156 into and out of the telescopic actuator 100. The pressure source 152 can be any passive pressure sources suitable to apply a fluid pressure. According to a pressure value to maintain corresponding to a load need of the telescopic actuator 100, a passive pressure source may passively react to a stress variation and induce fluid inflow/outflow. For example, the pressure source 152 can include at least two pressure accumulators 152A and 152B respectively connected to the conduits 154 and 156, whereby the fluids supplied by the pressure accumulators 152A and 152B can be respectively flowed through the conduits 154 and 156 into the telescopic actuator 100.

According to an embodiment, the pressure source 152 can supply compressed gas, and the pressure accumulators 152A and 152B can be gas pressure accumulators. It will be appreciated, however, that the pressure source 152 is not limited to this specific example. The pressure accumulators 152A and 152B may also be liquid pressure accumulators to form a liquid pressure source, or gas and liquid pressure accumulators to form a hybrid pressure source.

The pressure source 152 can include one or more pressure control valve so that a same fluid pressure or different fluid pressures can be provided at the output of the pressure source 152. Moreover, the pressure source 152 can include one or more flow control/directional control valves for controlling the flow speed/direction through the conduits 154 and 156. According to an embodiment, fluid can flow through the conduits 154 and 156 with a same flow speed. According to another embodiment, fluid can flow through the conduits 154 and 156 with different flow speeds.

For extending the telescopic actuator 100, the pressure accumulators 152A and 152B of the pressure source 152 can be operated so that a fluid is flowed into the hollow cavity 116 between the end 102A of the segment 102 and the end 104A of the segment 104 to create a fluid pressure P1 therein, and a fluid is flowed into the hollow cavity 118 of the segment 104 and the hollow cavity 120 of the segment 106 to create a fluid pressure P2 therein, wherein the fluid pressure P1 can differ from the fluid pressure P2. The fluid pressure P2 can result in a force F1 applied on the end surface 138 of the segment 106 in an extending direction, which causes the segment 106 to slide relative to the segments 102 and 104 in the extending direction. Moreover, the fluid pressure P2 can also create an opposing force F2 applied on the end surface 136 of the segment 104 in a retracting direction opposite to the extending direction. By adjusting the fluid pressure P1, a resulting pushing force F3 applied on the end surface 134 of the segment 104 in the extending direction can tend to offset the opposing force F2 so that the segment 104 can temporarily remain stationary during operation.

While the opposing force F2 and the pushing force F3 are approximately equal to each other, the extension of the segment 106 can cause the connected cavity formed by the hollow cavities 118 and 120 to increase in volume. As a result, the opposing force F2 becomes smaller, and the pushing force F3 can be greater than the opposing force F2 and urge the segment 104 to slide relative to the segment 102 in the extending direction. Because the surface area of the end surface 134 is greater than the surface area of the end surface 136 and the surface area of the end surface 138, the volume increase occurring inside the hollow cavity 116 between the end 102A of the segment 102 and the end 104A of the segment 104 can be greater than the volume increase of the connected cavity formed by the hollow cavities 118 and 120 during extension of the segments 104 and 106. Accordingly, when fluid is fed into the telescopic actuator 100 with a same flow speed, a relatively longer time is needed to fill in the volume inside the hollow cavity 116 between the end 102A of the segment 102 and the end 104A of the segment 104, which results in an extending speed of the segment 104 that is slightly slower than an extending speed of the segment 106. After the segment 104 has extended a certain length, the opposing force F2 and the pushing force F3 can become approximately equal and the segment 104 temporarily stops again. While the segment 106 continuously moves in the extending direction, the segment 104 thus can be in a floating state and slowly extend in a stop-and-go manner. This can prevent excessive impact of the segment 104 against the segment 102 when the segment 104 reaches the endpoint of its extending course, thereby preventing the occurrence of undesirable vibration and noise.

For retracting the telescopic actuator 100, fluid release can be conducted through the ports 110 and 112, and the segment 106 can slide relative to the segments 102 and 104 in the retracting direction under an external load applied thereon. The retraction of the segment 106 can cause the connected cavity formed by the hollow cavities 118 and 120 to decrease in volume. As a result, the opposing force F2 can become slightly greater than the pushing force F3, which causes the segment 104 to slide relative to the segment 102 in the retracting direction. Because the surface area of the end surface 134 is greater than the surface area of the end surface 136 and the surface area of the end surface 138, the volume decrease occurring inside the hollow cavity 116 between the end 102A of the segment 102 and the end 104A of the segment 104 can be greater than the volume decrease of the connected cavity formed by the hollow cavities 118 and 120 during retraction of the segments 104 and 106. Accordingly, a relatively longer time is needed for fluid release from the volume inside the hollow cavity 116 between the end 102A of the segment 102 and the end 104A of the segment 104, which results in a retracting speed of the segment 104 that is slower than a retracting speed of the segment 106. After the segment 104 has retracted a certain length, the opposing force F2 and the pushing force F3 can become approximately equal and the segment 104 temporarily stops again. While the segment 106 continuously moves in the retracting direction, the segment 104 thus can be in a floating state and slowly retract in a stop-and-go manner. This can prevent excessive impact of the segment 106 against the segment 104 when the segment 106 reaches the endpoint of its retracting course, thereby preventing the occurrence of undesirable vibration and noise.

In conjunction with FIGS. 1-4, FIG. 5 is a schematic view illustrating an embodiment of a motion simulating apparatus 200. Referring to FIGS. 1-5, the motion simulating apparatus 200 can include a support base 202, an occupant platform 204, the telescopic actuator 100, the pressure source 152 and the conduits 154 and 156. The support base 202 can extend generally horizontally, and can provide support for the occupant platform 204 and the telescopic actuator 100. According to an example of construction, the support base 202 can include a plate structure.

The occupant platform 204 is disposed above the support base 202, and is adapted to carry one or more occupants. The telescopic actuator 100 is disposed between the support base 202 and the occupant platform 204, the segment 102 of the telescopic actuator 100 being connected to the support base 202, and the segment 106 of the telescopic actuator 100 being connected to the occupant platform 204. Like previously described, the pressure source 152 can be respectively connected to the ports 110 and 112 of the telescopic actuator 100 via the conduits 154 and 156. During operation, the telescopic actuator 100 can extend and retract to cause upward and downward motions of the occupant platform 204.

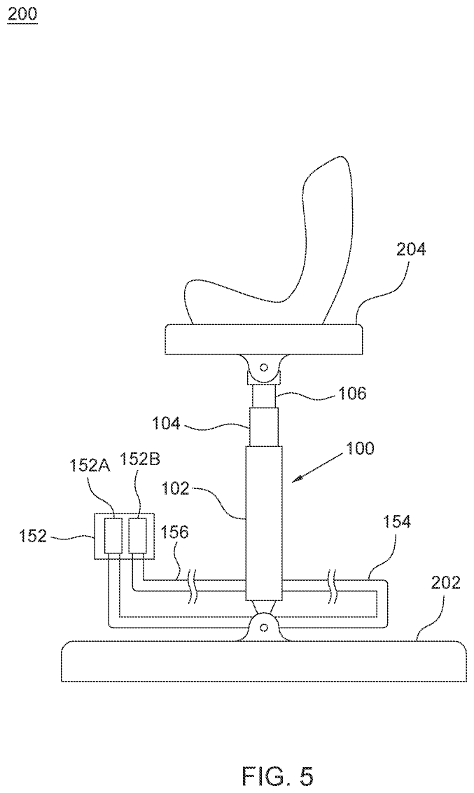

It will be appreciated that although the illustrated example of FIG. 5 shows one telescopic actuator 100, the motion simulating apparatus 200 is not limited to the illustrated example. The motion simulating apparatus 200 may include other actuators (not shown) for driving various motions of the occupant platform 204 as desired.

Advantages of the structures described herein include the ability to provide a telescopic actuator having a plurality of telescopically connected segments, wherein one of the segments can be configured to be in a floating state and extend or retract in a stop-and-go manner during operation. This can prevent excessive impact between segments that could produce undesirable vibration and noise and cause structural damages. The telescopic actuator described herein is suitable for use in actuating systems, and may be particularly advantageous for applications such as motion simulating apparatuses.

Realizations of the structures have been described only in the context of particular embodiments. These embodiments are meant to be illustrative and not limiting. Many variations, modifications, additions, and improvements are possible. Accordingly, plural instances may be provided for components described herein as a single instance. Structures and functionality presented as discrete components in the exemplary configurations may be implemented as a combined structure or component. These and other variations, modifications, additions, and improvements may fall within the scope of the claims that follow.

What is claimed is:

1. A telescopic actuator comprising:
a first segment having a first hollow cavity;
a second segment slidably connected to the first segment through the first hollow cavity, the second segment having a second hollow cavity insulated from the first hollow cavity;
a third segment slidably connected to the second segment through the second hollow cavity, the third segment having a third hollow cavity communicating with the second hollow cavity;
a first port configured to flow fluid into and out of the first hollow cavity; and
a second port configured to flow fluid into and out of the second hollow cavity and the third hollow cavity.

2. The telescopic actuator according to claim 1, wherein the second segment has an end that is located inside the first hollow cavity and has a first end surface and a second end surface facing opposite directions, the first end surface being configured to contact with a fluid inside the first hollow cavity, the second end surface being configured to contact with a fluid inside the second hollow cavity, and the first end surface having a surface area greater than a surface area of the second end surface.

3. The telescopic actuator according to claim 2, wherein an end of the third segment has a third end surface configured to contact with a fluid inside the third hollow cavity, the surface area of the second end surface being greater than a surface area of the third end surface.

4. The telescopic actuator according to claim 2, wherein the first hollow cavity is configured to receive a fluid that contacts with the first end surface and creates a buffer pressure, which results in a pushing force applied on the first end surface that tends to offset an opposite force applied on the second end surface owing to a fluid pressure inside the second and third hollow cavities.

5. The telescopic actuator according to claim 1, wherein the first port and the second port are disposed on the first segment.

6. The telescopic actuator according to claim 5, further comprising a third port communicating with the first hollow cavity, the third port being disposed on the first segment and being spaced apart from the first port along a lengthwise axis of the telescopic actuator, the second segment having an end that is slidable inside the first hollow cavity between the first port and the third port.

7. The telescopic actuator according to claim 5, wherein the first hollow cavity extends between a first end and a second end of the first segment, the first port and the second port being disposed on the first end of the first segment, and the second segment extending outward from the second end of the first segment.

8. The telescopic actuator according to claim 5, wherein the second port is connected to a flowing tube so that fluid can be flowed through the second port and the flowing tube into and out of the second hollow cavity and the third hollow cavity.

9. The telescopic actuator according to claim 8, wherein the flowing tube extends inside the first hollow cavity, the second hollow cavity and the third hollow cavity.

10. The telescopic actuator according to claim 8, wherein an end of the second segment is located inside the first hollow cavity and has an opening, the flowing tube extending through the opening into the second hollow cavity.

11. The telescopic actuator according to claim 10, wherein the end of the second segment has a fluid seal disposed adjacent to the opening, the fluid seal being disposed around a circumference of the flowing tube.

12. The telescopic actuator according to claim 1, wherein any of the first port and the second port is a gas port or a liquid port.

13. A motion simulating apparatus comprising:
a support base;
an occupant platform adapted to carry one or more occupants; and
the telescopic actuator according to claim 1, wherein the first segment is connected to the support base, and the third segment is connected to the occupant platform.

14. An actuating system comprising:
a telescopic actuator comprising a plurality of telescopic segments, a first port and a second port, wherein the telescopic segments comprise at least a first segment having a first hollow cavity, and a second segment having a second hollow cavity, the second segment being slidably connected to the first segment through the first hollow cavity, the first hollow cavity and the second hollow cavity being insulated from each other, the first port being configured to flow fluid into and out of the first hollow cavity, and the second port being configured to flow fluid into and out of the second hollow cavity; and
a pressure source respectively connected to the first port and the second port via a first conduit and a second conduit;
wherein the second segment has an end that is located inside the first hollow cavity and has a first end surface and a second end surface facing opposite directions, the first end surface being configured to contact with a fluid inside the first hollow cavity, the second end surface being configured to contact with a fluid inside the second hollow cavity, and the pressure source being operable to create different fluid pressures in the first hollow cavity and the second hollow cavity so that the second segment is in a floating state and is movable in an extending direction in a stop-and-go manner.

15. The actuating system according to claim 14, wherein the pressure source comprises a first pressure accumulator and a second pressure accumulator, the first pressure accumulator being connected to the first conduit, and the second pressure accumulator being connected to the second conduit.

16. The actuating system according to claim 14, wherein the first port and the second port are disposed on the first segment.

17. The actuating system according to claim 16, wherein the first hollow cavity extends between a first end and a second end of the first segment, the first port and the second port being disposed on the first end of the first segment, and the second segment extending outward from the second end of the first segment.

18. The actuating system according to claim 16, wherein the second port is connected to a flowing tube so that fluid can be flowed through the second port and the flowing tube into and out of the second hollow cavity.

19. The actuating system according to claim 18, wherein an end of the second segment is located inside the first hollow cavity and has an opening, the flowing tube extending through the opening into the second hollow cavity.

20. The actuating system according to claim 19, wherein the end of the second segment has a fluid seal disposed adjacent to the opening, the fluid seal being disposed around a circumference of the flowing tube.
